(19) United States
(12) Patent Application Publication
(10) Pub. No.: US 2009/0130247 A1
(43) Pub. Date: May 21, 2009

(54) METHOD FOR EXTRACTING OILSEED AND USE OF THE RESULTANT PRODUCT

(75) Inventors: Ian C. Purtle, Plymouth, MN (US); Aharon M. Eyal, Jerusalem (IL)

Correspondence Address: CARGILL, INCORPORATED, 15407 MCGINTY ROAD WEST, WAYZATA, MN, 55391, US

(73) Assignee: Cargill, Incorporated, Wayzata (MN)

(21) Appl. No.: 11/908,273

(22) PCT Filed: Mar. 9, 2006
(86) PCT No.: PCT/US06/08775

§ 371 Date: Jan. 8, 2009

(51) Int. Cl. A23K 1/18; A23L 1/20; A23K 1/14

(52) U.S. Cl. 426/2; 426/431; 426/430; 426/601

(57) ABSTRACT

There is described a method for extracting an oilseed material from which less than 20% of oil has been previously extracted. The extraction is carried out using an aqueous extractant to form an extracted oilseed material and a water-soluble carbohydrate-containing extract. Also, disclosed are the extracted products of the method, and the use thereof in producing foods and feeds.

### RELATED APPLICATIONS

The present application claims priority to U.S. Provisional Patent Application Ser. No. 60/660,154, filed Mar. 9, 2005 and to U.S. Provisional Patent Application Ser. No. 60/660,807, filed Mar. 11, 2005, the entire contents of each of which are incorporated by reference.

### FIELD OF THE DISCLOSURE

The present disclosure is directed to a method for extracting oilseed to produce a product comprising oilseed protein, oilseed oil and optionally water-soluble carbohydrates. Also disclosed is use of the extracted product in the preparation of foods and feeds, such as fish and animal feeds.

### BACKGROUND OF THE INVENTION

Aquaculture is a fast-growing industry, growing shrimp and various fish, such as salmon, tilapia, halibut, carp, channel catfish, trout, sea bream and sea bass. A significant cost in aquaculture is that of feed, which should be of high protein and fat concentrations and low on anti-nutritional factors (ANF). Fishmeal and fish oil are in most cases the preferred source for the protein and fat, but their availability is limited. Aquaculture production is expected to grow several times in the coming decades, while fishmeal and fish oil production will be about constant.

It is generally known to provide soy protein in the form of soybean meal (SBM), which is a co-product of extracting soybean oil from the bean. However, SBM has several disadvantages as fish feed. It is low in oil, about 1-2%, and its protein concentration is relatively low, about 45%. It contains relatively high concentration of water-soluble carbohydrates, mainly sucrose, stachiose and raffinose, and of minerals, which together dilute the nutrients, have no nutritional value for many of the varieties of fish and, according to some studies, may have a negative effect. It is also known to feed soy protein concentrate (SPC) to fish, which is more concentrated in protein and lower on water-soluble carbohydrates, but more expensive and, as SBM, is low in oil.

Accordingly, there is a need for a feed ingredient that is concentrated in oilseed protein (e.g. soy protein) and oilseed oil (e.g. soy oil) and is low in water-soluble carbohydrates, minerals and ANF and is of suitable cost. There is also a need for a method for efficient and low-cost production of such feed ingredient and for a method for using such ingredient in fish and animal feed. It would be advantageous to provide a feed ingredient, method of production and method of application filling any one or more of these needs or having other advantageous features. Soybean protein is a suitable replacement to fishmeal protein in view of its amino acid composition, availability and cost and in view of BSE-related difficulties in using animal protein and fat. Vegetable oil, including soybean oil can replace part of the fish oil.

### SUMMARY OF THE DISCLOSURE

The present disclosure is directed, in one embodiment, to a method for extracting oilseed from which less than 20% of the oil has been previously extracted, with an aqueous extractant, to provide an extracted product comprising oilseed protein, oilseed oil, and optionally water-soluble carbohydrates. The disclosure is also directed to the extracted product obtained by the extraction method herein. Further, the disclosure is directed to use of the extracted product in the preparation of food and feed, such as fish feed and animal feed.

### DETAILED DESCRIPTION OF THE DISCLOSURE

The present disclosure is directed, in one embodiment, to a method for extracting oilseed from which less than 20% of the oil has been previously extracted, with an aqueous extractant, to provide an extracted product comprising oilseed protein, oilseed oil, and optionally water-soluble carbohydrates. The disclosure is also directed to the extracted product obtained by the extraction method herein. Further, the disclosure is directed to use of the extracted produced in the preparation of food and feed, such as fish feed and animal feed.

In one embodiment, the oilseed from which less than 20% of the oil has been previously extracted, that is subjected to the extraction with an aqueous extracted herein, may be any oilseed. Suitable oilseeds that may be extracted include, but are not limited to, soybeans, rapeseed, sunflower, cottonseed, corn germ, flax, safflower, canola, peanuts, any oilseed that yields oil, and the like. In one embodiment, the oilseed that is extracted is soybean.

In the extraction method herein, the oilseed is extracted with an aqueous extractant. Any aqueous extractant may be used that will allow the extraction to occur. In one embodiment, the aqueous extractant is an aqueous solution. In another embodiment, the aqueous solution comprises an organic solvent, such as an alkanol having about 1-4 carbon atoms. Suitable alkonols include, but are not limited to those of considerable solubility in water such as methanol, ethanol, propanol, iso-propanol, butanol, iso-butanol, and tert-butanol. In another embodiment, the concentration of the alkanol in the aqueous extractant ranges from about 20% to about 90%, and in another embodiment, from about 50% to about 80%. In another embodiment, the aqueous extractant is an aqueous solution of ethanol wherein the ethanol concentration ranges from about 50% to about 80%. In another embodiment, the pH of the aqueous extractant is adjusted to slightly acidic. In a further embodiment, the pH of the aqueous extractant is in the range of about 3.2 to about 5.2.

The extractant method comprises contacting the oilseed material with the aqueous extractant, in any apparatus suitable for the extraction process. In one embodiment, the extraction involves at least two contacts, conducted in a counter-current mode. In another embodiment, the contact time for the extraction may range from about 0.1 minute to about 120 minutes, and in another embodiment, from about 1 minute to about 20 minutes.

In another embodiment, the oilseed material that is to be extracted with the aqueous extractant may contain water-soluble carbohydrates, such as sucrose, stacheose, and raffinose, as well as ashes, that are mainly inorganic salts. In one embodiment, the present extraction method results in at least about 70% of the water soluble carbohydrates and/or ashes being transferred into the extract, and in another embodiment, at least about 90% being transferred into the extract.

In another embodiment, the resulting extracted product of the present extraction method may be separated from the extract. The extracted oilseed product resulting from the extraction is relatively highly concentrated in oilseed protein, such as soybean protein, and oilseed oils, such as soybean oil, and is relatively low in water-soluble carbohydrates and anti-nutritional factors. In one embodiment, the extracted product comprises at least about 40% to about 80% oilseed protein, and in another embodiment, at least 45% oilseed protein, and in still another embodiment, at least about 50% oilseed protein. In another embodiment, the extracted product comprises at least about 12% to about 25% oilseed oil, and in another embodiment, at least about 15% oil, and in still another embodiment, at least about 20% oil. In another embodiment, the extracted product comprises less than about 8% to about zero percentage water-soluble carbohydrates, and in another embodiment, less than about 7% water-soluble carbohydrates, and in still a further embodiment, less than about 3% water-soluble carbohydrates.

In another embodiment, the extracted product resulting from the present extraction method may be used in the preparation of foods and/or feeds, such as fish feed or animal feed. The extracted product may be present in the foods or feeds in an amount of about 1 to about 99%, in one embodiment and in another embodiment in an amount from about 20 to 80%, based on the total food or feed composition. The food or feed compositions may be prepared in any manner, such as physically mixing or blending the extracted product comprising oilseed protein, oilseed oil and optionally, water soluble carbohydrates, with the food or feed composition.

In another embodiment, the oilseed material to be extracted, from which less than 20% of oil has been previously extracted, may be pretreated, prior to extraction with an aqueous extractant. The pretreatment may involve cleaning, dehulling, tempering, heating, extrusion, flaking, expansion, or a combination thereof.

### ALTERNATE EMBODIMENTS OF THE DISCLOSURE

A. A method of producing fish feed comprising the step of blending the extracted product of the extraction method herein with at least one of fish meal, other protein sources, fish oil, vegetable oil, minerals, methionine, lysine, other amino acids, anti-oxidants, attractants and palatability enhancers.

B. A method for growing fish comprising feeding to fish a feed produced according to the method of A.

C. The method of B, wherein young fish are fed fish feed containing at least one palatability enhancer and/or attractant.

D. The method of B, wherein fish are fed fish feed containing fish oil and/or poly-unsaturated fatty acids, during at least about one week at the end of the growth period.

E. A method for the production of an extracted product comprising oilseed protein, oilseed oil, and optionally, water-soluble carbohydrates, comprising the step of extracting an oilseed from which less than 20% of oil has been previously extracted, with an aqueous extractant to form extracted oilseed material and optionally, carbohydrates containing extract.

F. The method of E, wherein the aqueous extractant comprises a low-molecular weight alkanol selected from the group consisting of methanol, ethanol, propanol, iso-propanol, butanol, iso-butanol and tert-butanol.

G. The method of F, wherein the alkanol is ethanol and the concentration of the ethanol in the extractant is in the range from about 20% to about 90%.

H. The method of G, wherein the ethanol concentration in the aqueous extractant is in the range from about 50% to about 80%.

I. The method of extracting an oilseed with an aqueous extractant comprising at least two extracting stages.

J. The method of I, wherein the extraction is conducted in a counter-current mode.

K. The method of contacting the oilseed with aa aqueous extractant, wherein contacting time is in the range from about 0.1 minute to 120 minutes.

L. The method of extracting an oilseed from which less than 20% of oil has been previously extracted, with an aqueous extractant, wherein at least about 70% of the water-soluble carbohydrates and/or ashes of the extracted oilseed material are transferred into the extract.

M. The method of L, wherein at least about 90% of the water-soluble carbohydrates and/or ashes of the extracted oilseed material are transferred into the extract.

N. The method of E, further comprising the step of separating the extracted material from the extract to form separated extract and separated extracted material.

O. The method of N, wherein the separated extracted material is desolventized and/or dried.

P. The method of N, wherein the separated extracted material is heat treated.

Q. The method of N, wherein the extractant comprises ethanol and the separated extract is distilled to recover contained ethanol.

R. The method of Q, wherein the recovered ethanol is reused for extracting the oilseed material from which less than 20% oil has been previously extracted.

S. The method of E, wherein the oilseed material is treated prior to extraction.

T. The method of S, wherein the pretreatment comprises at least one of dehulling, tempering, flaking, expansion, heating, extrusion and washing with water.

U. The method of E, wherein the pH of the extractant is adjusted to a pH in the range from about 3.2 to about 5.2.

V. The method of E, wherein the oilseed material is treated with an enzyme or with an organism with phytase activity prior to contacting, with the extractant, during contacting or after contacting.

W. The method of E, further comprising a step of washing with water prior to contacting with the extractant or after contacting with the extractant.

X. The method of E, further comprising adding proteinic material to the oilseed material prior to, during, or after, contacting with extractant.

Y. The method of E, further comprising at least one of surface treatment, coating, casing, encapsulation and addition of at least one of gelatin, binder, starch, surfactant and other ingredients presently added in fish feed manufacture.

Z. The extracted product comprising oilseed protein, oilseed oil, and optionally, water soluble carbohydrates, wherein the oil does not substantially separate upon application of a centrifugal force (e.g. by a centrifuge).

### BRIEF DESCRIPTION OF THE DRAWINGS

FIG. 1 is a schematic diagram of an exemplary embodiment of the present disclosure.

### DETAILED DESCRIPTION OF ALTERNATE EMBODIMENTS

The extracted product of the present method is relatively highly concentrated in oilseed protein (e.g. soybean protein) and oilseed oil (e.g. soybean oil) and is relatively low in water-soluble carbohydrates and anti-nutritional factors. According to one embodiment, the product comprises at least about 40% oilseed protein, more suitably at least about 50%. According to another embodiment, the product comprises at least about 12% soybean (e.g. soybean) oil, in another embodiment, at least about 15%, an in another embodiment, at least about 20%. According to another embodiment, the extracted product comprises less than about 8% water-soluble carbohydrates, and in another embodiment less than about 3%.

According to another embodiment, the extracted product of the present method may be used as an ingredient of fish feed. The protein content of the extracted product forms at least about 15% of the total protein content of the fish feed, in another embodiment at least about 30%, and in another embodiment at least about 50%.

Another embodiment of the invention is a method of producing fish feed. The method comprises blending the extracted product of the method herein with at least one of fish meal, another protein source, e.g. soy protein concentrate and toasted soybeans, fish oil, vegetable oil, minerals such as calcium or phosphorous compounds, methionine, lysine, other amino acids, anti-oxidants, attractants, keratine hydrolyzate, betaine, inosinate and palatability enhancers. Optionally, the extracted product is treated prior to blending. The blend can be further processed using steps such as drying, extruding and pelletizing.

Another embodiment of the invention is a method for growing fish comprising feeding to fish the feed comprising the extracted product and/or the extracted product produced according to the method of the invention. According to another embodiment, feed fed, particularly to young fish, comprises at least one palatability enhancer and/or attractant for a period of adjustment. The amount of palatability enhancer and/or attractant is decreased over time. According to another embodiment, fish are fed fish feed containing fish oil and/or poly-unsaturated fatty acids during at least about one week at the end of the growth period.

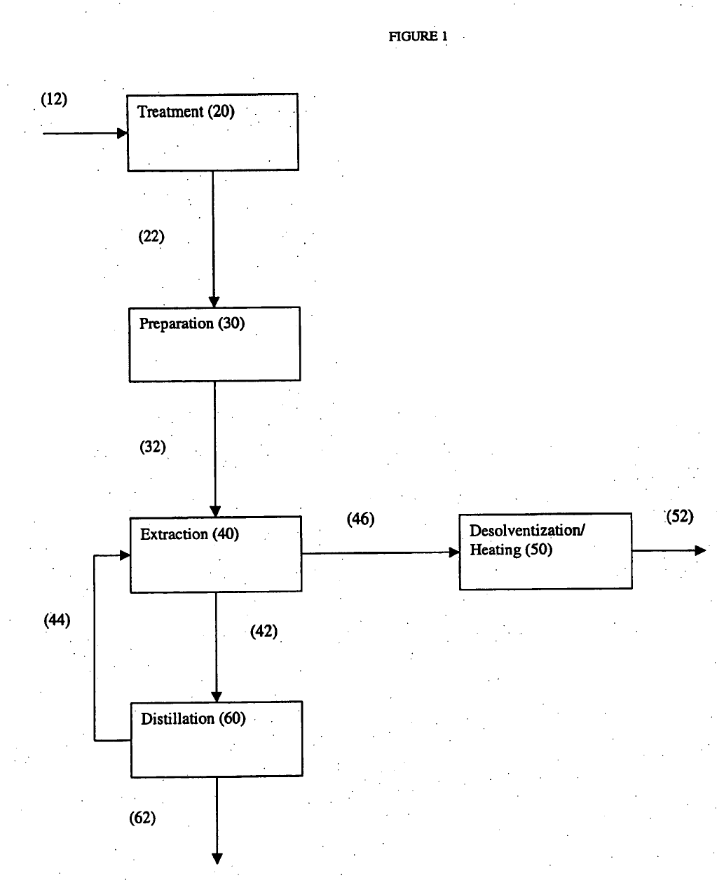

FIG. 1 is a schematic diagram of an exemplary embodiment of the method for the production of the product herein. The method comprises extracting in step (40) an oilseed from which less than 20% of oil has been previously extracted (32) with an aqueous extractant (44) to form extracted oilseed material (46) and an extract (42) containing carbohydrates. Hence, formation of oilseed material does not necessarily involve a step such as pressing out oil or extracting it with a solvent such as hexane. Formation of the oilseed material may involve treating (step 20) oilseeds (12), by known methods, such as cleaning and/or dehulling to form treated material (22), which could be further prepared for extraction in operation (30). Such preparation may involve known operations, such as tempering, heating, extrusion, flaking and/or expansion. The prepared oilseed material (32) is then fed to the extraction step. If desired, oilseed material, such as proteinic material, soybean meal and partially extracted soybean material can be added to the treated oilseed material in (22) or to the prepared oilseed material in (32).

According to another embodiment, the aqueous extractant (44) is an aqueous solution. Such aqueous solution comprises according to one embodiment, an organic solvent, such as an alkanol having about 1-4 carbon atoms. Suitable alkanols are ones of considerable solubility in water, such as methanol, ethanol, propanol, iso-propanol, butanol, iso-butanol and tert-butanol. According to one embodiment, the concentration of the organic solvent, such as, alkanol in the aqueous extractant is from about 20% to about 90%, and in another embodiment, from about 50% to about 80%. According to one embodiment, the extractant is an aqueous solution of ethanol and the ethanol concentration is in the range from about 50% to about 80%.

According to one embodiment, the pH of the extractant is adjusted to slightly acidic, and in another embodiment, in the range from 3.2 to 5.2.

Extraction in step (40) involves contacting the oilseed material with the extractant. Such contacting is preferably done in an extractor, e.g. one of the kind used for production of soy protein concentrate. According to one embodiment, extraction involves at least two contacts conducted in a counter-current mode. Contacting time according to one embodiment is in the range from about 0.1 minute to about 120 minutes and in another embodiment from 1 minute to 20 minutes. Contacting temperature is a matter of optimization. Elevated temperatures improve extraction, but temperature is preferably maintained in a range where extractant partial vapor pressure is easy to handle.

The oilseed material in (32) contains water-soluble carbohydrates, such as sucrose, stachiose and raffinose and ashes, mainly inorganic salts. According to one embodiment of the present invention, at least about 70% of those water-soluble carbohydrates and/or ashes are transferred into the extract, and in another embodiment at least about 90%.

According to one embodiment, other components of the oilseed material are also extracted. Those may include mineral salts that dilute the protein and the oil content of the extracted product. At least for some of the food or feed applications of the extracted product, at least partial extraction of isoflavones is also desired. Also desired is at least partial removal of phytic acid from the oilseed material.

According to one embodiment, the method comprises a step of separating the extracted material from the extract to form separated extract (42) and separated extracted oilseed material (46). The separated extracted material can be further treated in step (50). According to one embodiment, such further treatment involves desolventization and/or heat treatment. Desolventization removes residual extractant. Heat treatment facilitates desolventization. The process deactivates anti-nutritional factors (ANFs), such as inhibitors of protein-digestion enzymes—mainly trypsin and chymotrypsin inhibitors. Another group of deactivated ANFs are the lectins (also referred to as agglutinins). Also reduced is the antigenic effects of soy proteins.

Heat treatment involves heating to a temperature in the range from about 70° C. to about 200° C., according to one embodiment. Heating duration is preferably in the range from about 0.1 to about 120 minutes. A small level of moisture, about 10%, might be desired. In one embodiment, temperature is adjusted according to the product requirements, taking into consideration the alkanol concentration in the extractant. Concentrated ethanol solutions contribute to deactivation of some anti-nutritional factors, particularly proteinic ones and enables lower temperatures in the heat treatment. If desired, the temperature of the heat-treatment step can be further decreased by the addition of mechanical energy, such as shear force and/or by reagents that interact with sulfur-sulfur bonds, e.g. ones that carry S—H moieties and/or sulfite.

Heat treatment in order to deactivate anti-nutritional factors could also be conducted prior to extraction, but according to one embodiment it is better done after extraction, allowing for better integration with desolventization.

According to one embodiment, the extracted product of the method is expected to have a higher availability of amino acids compared with some of the commercial higher quality soy protein.

The composition of the extractant, in one embodiment to the present invention is preferably such that oil is not extracted along with the carbohydrates. Therefore, ethanol solutions, when used as extractants, are in one embodiment less than about 90% ethanol. If extracted, oil can be separated and used as such or re-added to feed ingredient. That, however, involves extra cost. Leaving the oil in the product is advantageous since oilseedoil is an important ingredient of the fish feed of the present invention. The same is true for phospholipids.

A composition similar to the extracted product herein can be achieved by blending oilseed, e.g. soybean oil, phospholipids and fatty acids (or crude oil) with purified soy protein such as soy protein concentrate. The product of the present invention is characterized in that the lipids contained are non-extracted. In addition, compared with the method of preparing the feed herein, such blending of lipids results in a more expensive product due to the extra costs related to extraction of oilseed oil with hexane and desolventization of the oil.

The extracted, desolventized and heat-treated oilseed material (52) can be used as such or further treated, if desired. Such further treatment may involve steps such as the addition of components, blending with other feed ingredients and pelleting or extrusion. For example, for feeding some fish types, methionine addition to the product is desired.

If desired, a step of washing with water is introduced at any stage of the process, e.g. prior to the extraction or after it. Such wash can remove components that are less soluble in the extractant or can facilitate extraction.

According to one embodiment, the oilseed material is enzymatically treated at any stage of the process. According to one embodiment, the oilseed material is treated with enzymes or organisms having phytase activity in order to hydrolyze contained phytate. Such enzymatic treatment may take place prior to, during, or after contacting with the extractant.

The separated extract (42) comprises at least part of the extractant components, e.g. water and ethanol and extracted components, e.g. carbohydrates and possibly others, such as, isoflavones, amino acids, mineral salts, peptides and water-soluble proteins. The extract can be treated by distillation (60) to separate the alkanol, e.g. ethanol from it. The separated alkanol (44) is preferably recycled to reform the extractant.

According to one embodiment, a part of the separated alkanol, e.g. ethanol, is concentrated to its azeotropic concentration or to higher concentration. The concentrated alkanol is used to extract oil from oilseed material to produce oilseed material that is at least partially defatted and an oil-containing extract. The produced oilseed material could be combined with the feed ingredient herein at any convenient stage, e.g. after extraction (40) and before desolventization (50). The oil-containing extract can be processed for oil recovery, e.g. by distilling the solvent, by lowering the temperature of the extract and/or by water addition. After oil separation, the solvent could be processed separately or with the solvent in stream (42) or (62).

The residual stream (62) can be added to animal feed, as such, or after further treatment, and/or treated to recover valuable components out of it, e.g. isoflavones. Also possible is fermenting the sugar content to form valuable products, e.g. ethanol and feed ingredient.

The product of the present invention may have a ratio of oilseed oil to oilseed protein similar to that of the oilseed. The ratio can be modified by adding oil and/or protein. Such protein can be in any desired form, e.g. toasted, meal, or protein concentrate, which can be added at any stage of the process and/or to the final product. Toasted oilseed and oilseed meal are of relatively low cost, but have the disadvantage of relatively dilute nutrient and high concentration of carbohydrates. Their addition to the product is determined by cost consideration and by the product requirements such as nutrients concentration and acceptable level of carbohydrates.

### EXAMPLES

While the invention will now be described in connection with certain embodiments in the following examples so that aspects thereof may be more fully understood and appreciated, the examples are not intended to limit the invention to these particular examples.

Soybeans were dehulled, cracked and screened. Two size fraction were collected for further testing: from 0.354 to 1.68 mm (Size I) and (ii) smaller than 0.354 mm (Size II). Those particles are referred to here as full-fat particles.

12.5 gr samples of full-fat particles from each size were extracted at 40° C. with 60 gr hexane for 2 hours. After phase separation, the particles were extracted again with 40 gr hexane. Then the particles were separated and desolventized. The particles formed are referred to here as defatted particles.

Four types of particles were extracted with ethanol-water solutions composed of 70% wt. ethanol and 30% wt. water: (i) small full-fat particles, (ii) large full-fat particles, (iii) small defatted particles and (iv) large defatted particles. In each case, 1.4 gr of particles and 8.4 gr of the ethanol solution were extracted at 40° C. or 60° C. for 3 hours. The extracts from each extraction were analyzed. The results are summarized in the following table.

| Vial | Particle size (mm) | | Extracted into the | Daidzin + glycitin | Genistin |
|---|---|---|---|---|---|
| No. | and pretreatment | Conditions | ethanol solution Wt %* | ppm* | ppm* |
| 1 | 0.354-1.68 full-fat | 3 hr, 40° C. | 16.9 | 146 | 468 |
| 2 | 0.354-1.68 defatted | 3 hr, 40° C. | 15.2 | 158 | 483 |
| 3 | <0.354 full-fat | 3 hr, 40° C. | 18.7 | 212 | 618 |
| 4 | <0.354 defatted | 3 hr, 40° C. | 19.1 | 223 | 630 |
| 5 | 0.354-1.68 full-fat | 3 hr, 60° C. | 19.1 | 210 | 616 |
| 6 | 0.354-1.68 defatted | 3 hr, 60° C. | 17.3 | | |
| 7 | <0.354 full-fat | 3 hr, 60° C. | 20.3 | 278 | 635 |

*Calculated per weight of the treated particles

The results show that total extraction with the ethanol solution from full-fat particles is similar to that from defatted ones. These results demonstrate that the presence of oil does not interfere with the extraction of the main ethanol-water soluble components—carbohydrates and minerals. Furthermore, isoflavones extraction with the ethanol solution from full-fat particles is similar to that from defatted ones. These results demonstrate that the presence of oil does not interfere with the extraction of isoflavones, which are more hydrophobic in nature than the carbohydrates and the minerals. Extraction yield of carbohydrates, minerals and isoflavones increases with decreasing particle size and with increasing extraction temperature.

The extracts were also analyzed for co-extracted oil. The results (not presented in the table) show that oil extraction is low, typically less that 1% of the oil contained in the full-fat particles. In each of the examples of the present disclosure, the products resulting from extraction of the oilseed material are characterized by having a protein value above 55% and an oil value above 20%.

The results of the example demonstrate the feasibility of producing full-fat soy protein concentrate high in protein and oil is thus feasible. As used in this disclosure, the term “soy protein concentrate means and includes soybean material prepared from soybean seeds and having up to about 70% protein on a moisture free basis.

While the preferred and other exemplary embodiments described in this disclosure are presently preferred, it should be understood that these embodiments are offered by way of example only. For example, any oilseed or any seeds that yield oil such as soybean, canola, sunflower, peanut, etc. may be used according to alternative embodiments. The invention is not limited to a particular embodiment, but extends to various modifications, combinations, and permutations.

What is claimed is:

1. A method for treating an oilseed material from which less than 20% of oil has been previously extracted comprising extracting the oilseed material with an aqueous extractant to form extracted oilseed material and a water-soluble carbohydrates-containing extract.

2. The method of claim 1 wherein the oilseed material is soybean.

3. The method of claim 1 wherein the aqueous extractant is an aqueous solution comprising an organic solvent.

4. The method of claim 3 wherein the organic solvent is an alkanol having from about 1 to 4 carbon atoms.

5. The method of claim 4 wherein the alkanol is selected from the group consisting of methanol, ethanol, propanol, iso-propanol, butanol, iso-butanol, and tert-butanol.

6. The method of claim 3 wherein the concentration of the organic solvent in the aqueous extractant ranges from about 20% to about 90%.

7. The method of claim 6 wherein the concentration of the organic solvent ranges from about 50% to about 80%.

8. The method of claim 5 wherein the alkanol is ethanol.

9. The method of claim 1 wherein the extraction comprises at least two extracting stages.

10. The method of claim 9 wherein the extraction is conducted in a counter-current mode.

11. The method of claim 1 wherein the extracting time ranges from about 0.1 minute to about 120 minutes.

12. The method of claim 1 wherein at least about 70% of a component selected from the group consisting of water-soluble carbohydrates, ashes, and mixtures thereof, of the extracted oilseed material are transferred into the extract.

13. The method of claim 12 wherein at least about 90% of the component is transferred into the extract.

14. The method of claim 1 further comprising separating the extracted oilseed material from the water-soluble carbohydrates—containing extract.

15. The method of claim 1 wherein the oilseed material is pretreated prior to extraction with an aqueous extractant by a process selected from the group consisting of dehulling, tempering, flaking, expansion, heating, extrusion, washing with water, and mixtures thereof.

16. The method of claim 1 wherein the pH of the aqueous extractant is adjusted to a range of about 3.2 to about 5.2.

17. A product produced in accordance with the method of claim 1.

18. A composition comprising the product of claim 17 and a component selected from the group consisting of fish meal, other protein sources, fish oil, vegetable oil, a mineral, methionine, lysine, an amino acid, an anti-oxidant, an attractant, a palatability enhancer, and mixtures thereof.

19. The composition of claim 18 wherein the product of claim 17 is present in an amount ranging from about 1% to about 99% based on the total composition.

20. A method of producing a fish feed comprising blending the product of claim 17 with a component selected from the group consisting of fish meal, other protein sources, fish oil, vegetable oil, a mineral, methionine, lysine, an amino acid, an anti-oxidant, an attractant, a palatability enhancer, and mixtures thereof.

21. A method for growing fish comprising feeding to fish the fish feed produced in accordance with the method of claim 20.

22. The method of claim 21 wherein the fish are young fish and the fish feed comprises a component selected from the group consisting of at least one palatability enhancer, an attractant, and mixtures thereof.

23. The method of claim 21 wherein the fish feed comprises a component selected from the group consisting of fish oil, a polyunsaturated fatty acid, and mixtures thereof, and fish feed is fed to the fish during at least about one week at the end of the growth period.

24. A food or feed composition comprising the product of claim 17.
